(19) United States
(12) Patent Application Publication
(10) Pub. No.: US 2024/0391101 A1
(43) Pub. Date: Nov. 28, 2024

(54) WORKSPACE ADAPTIVE ROBOTIC SYSTEM TO LOAD OR UNLOAD PALLETS OR OTHER RECEPTACLES

(71) Applicant: Dexterity, Inc., Redwood City, CA (US)

(72) Inventors: Joseph Li, San Jose, CA (US); Robert Moreno, East Palo Alto, CA (US); Neeraja Abhyankar, Menlo Park, CA (US)

(21) Appl. No.: 18/670,253

(22) Filed: May 21, 2024

Related U.S. Application Data
(60) Provisional application No. 63/468,350, filed on May 23, 2023.

(51) Int. Cl. B25J 9/16

(52) U.S. Cl. CPC B25J 9/1664; B25J 9/1679; B25J 9/1697

(57) ABSTRACT

A robotic system to load or unload pallets or other receptacles is disclosed. Image data is received and used to identify an item associated with a topmost receptacle in a stack of one or more stackable receptacles. A robotic arm is controlled to perform a pick and place operation on the item with respect to the topmost receptacle in the stack of one or more stackable receptacles. Successive iterations of identifying, picking, and placing items are performed until a stop condition is determined to have been met, the stop condition including one or more of determining no further items remain to be processed and determining that the stack of one or more stackable receptacles includes a maximum permitted number of stackable receptacles.

### CROSS REFERENCE TO OTHER APPLICATIONS

This application claims priority to U.S. Provisional Patent Application No. 63/468,350 entitled WORKSPACE ADAPTIVE ROBOTIC SYSTEM TO LOAD OR UNLOAD PALLETS OR OTHER RECEPTACLES filed May 23, 2023 which is incorporated herein by reference for all purposes.

### BACKGROUND OF THE INVENTION

Robotic systems have been provided to remove items from and/or place/stack items on or in a receptacle, such as a pallet, container, tray, bin, or other receptacle. In the case of depalletization, for example, the following workflow is typical: One Pallet on the ground→Depalletize objects off the pallet→Continue until all objects are off the pallet→Remove the Pallet→Put in a new pallet full of items, and repeat.

The above workflow limits operational throughput. For example, for each iteration, the system may experience down time associated with removing an empty pallet and replacing it with a full pallet. Even systems that pick from one or more possible pallet locations may experience delays, since a robot may be able to clear multiple pallets in the time it takes for human or other workers to recognize the need to remove an empty pallet, obtain and use specialized equipment such as a forklift or pallet jack to remove the pallet, go (with such equipment) to a location at which a next full pallet is located, engage it with the forklift or jack, drive or push it to the depalletization location, and place it in the location for depalletization.

Similar delay can occur in performing the reverse operation, i.e., palletization in this example. Once a pallet has been filled, the system typically must wait for the completed pallet to be removed and a new, empty pallet (or other container) to be placed. The attendant delays limit throughput and increase the time and other costs associated with using a robotic system to remove items from or place items on or in a receptacle, such as a pallet.

### BRIEF DESCRIPTION OF THE DRA WINGS

Various embodiments of the invention are disclosed in the following detailed description and the accompanying drawings.

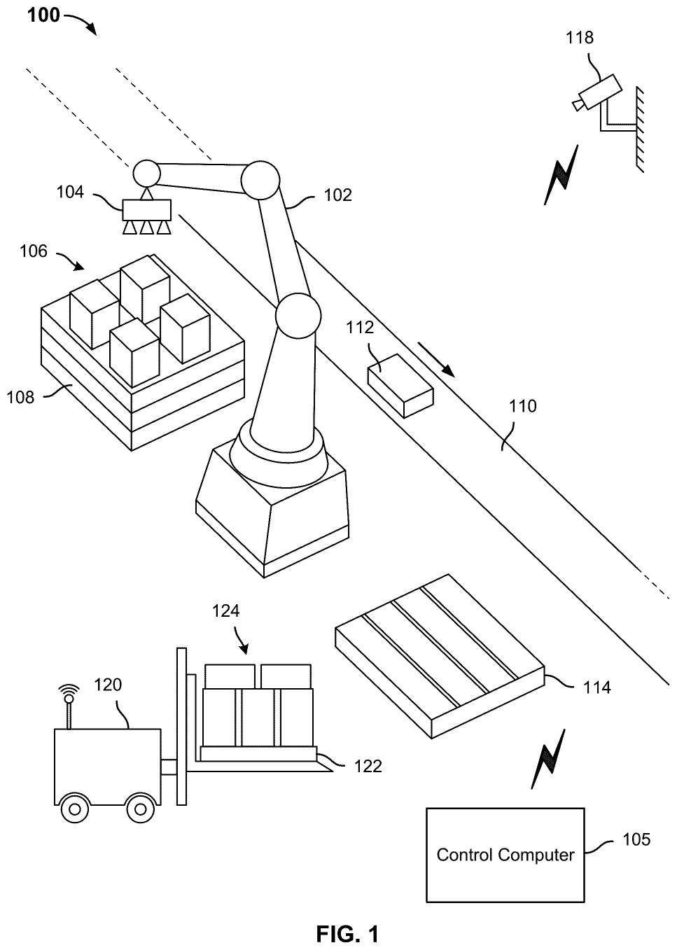

FIG. 1 is a block diagram illustrating an embodiment of a workspace adaptive robotic system.

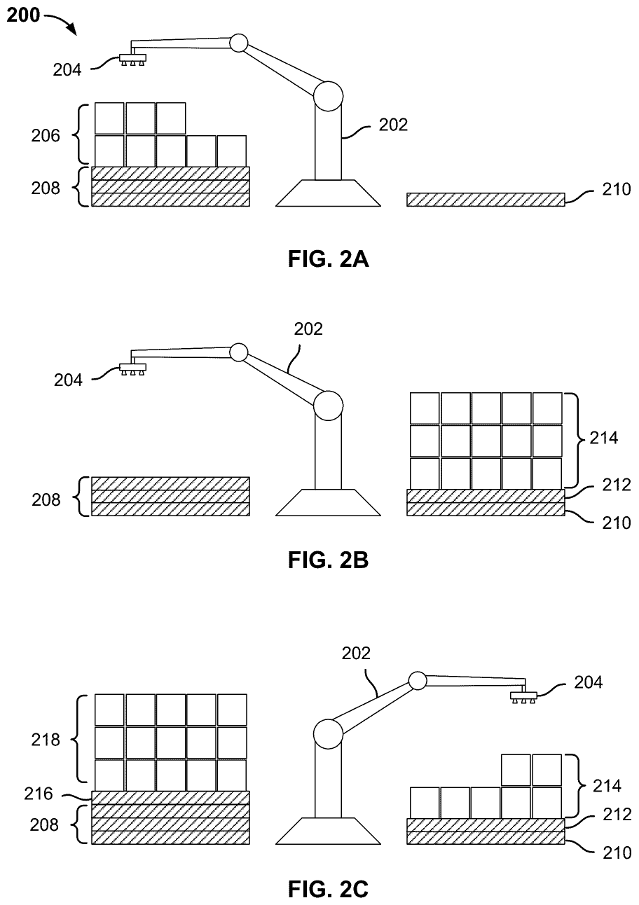

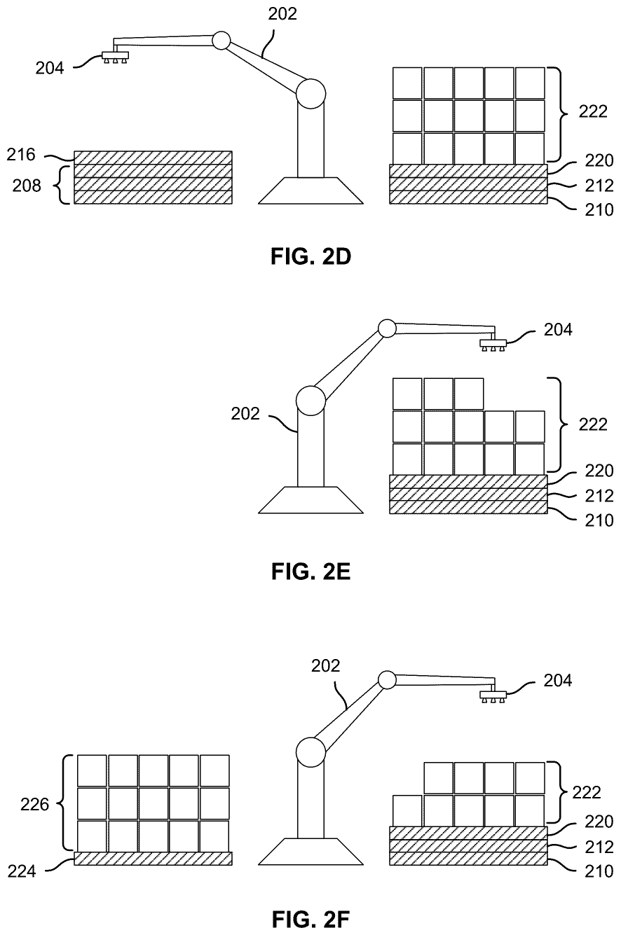

FIGS. 2A-2F are diagrams illustrating an embodiment of a workspace adaptive robotic system.

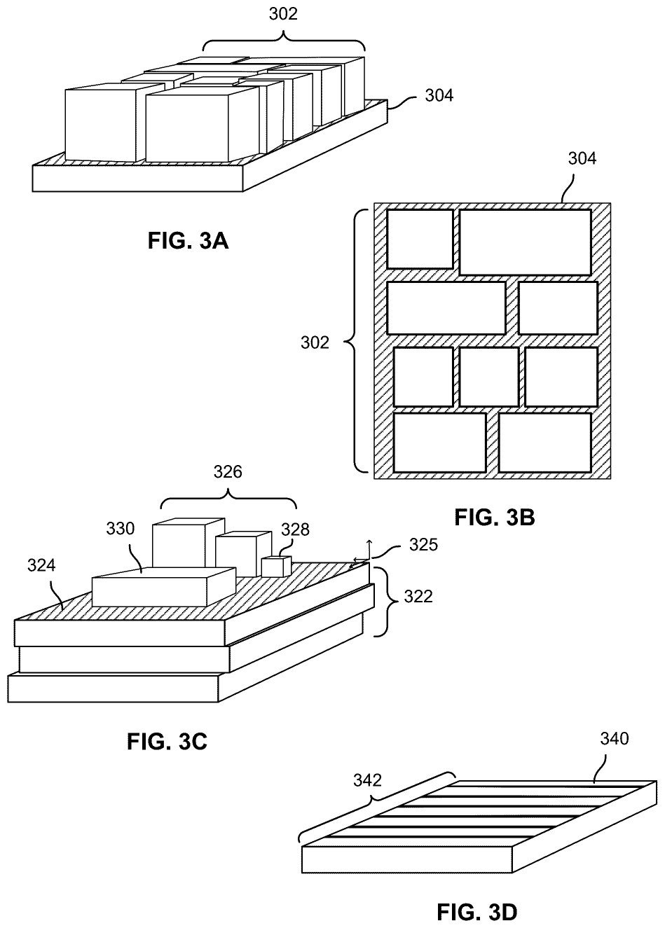

FIGS. 3A-3D are diagrams illustrating examples of pallets in various states of being loaded or unloaded, in an embodiment of a workspace adaptive robotic system.

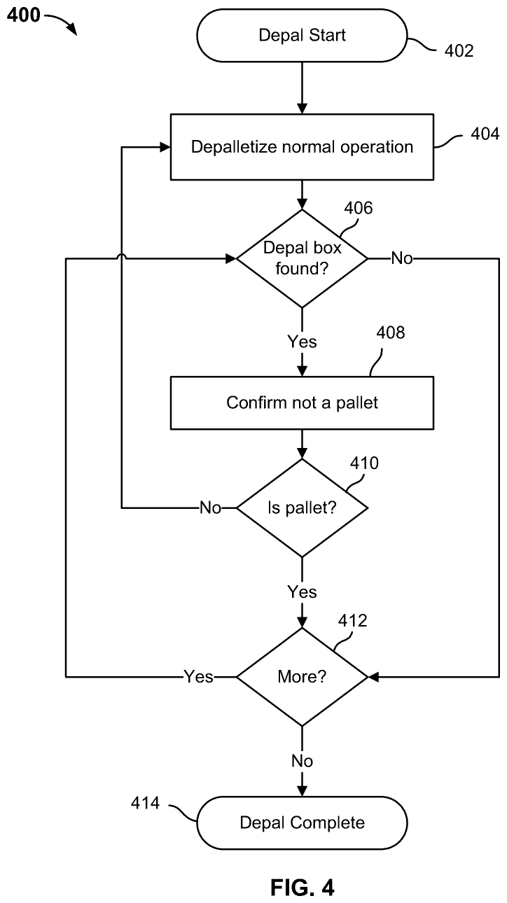

FIG. 4 is a flow chart illustrating a process to depalletize, in an embodiment of a workspace adaptive robotic system.

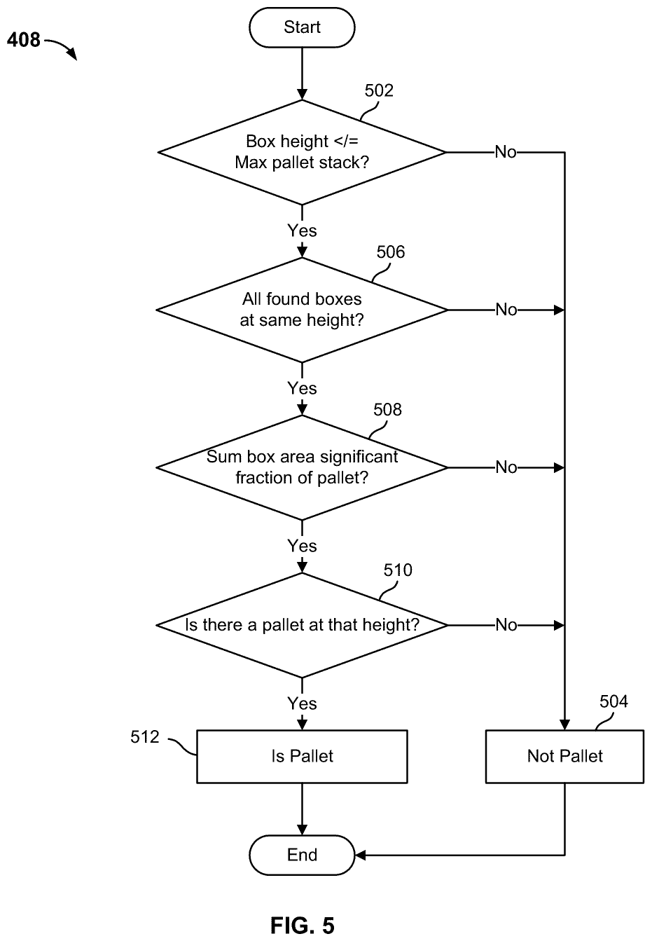

FIG. 5 is a flow chart illustrating a process to check that a pallet has not been identified mistakenly as a box in an embodiment of a workspace adaptive robotic system.

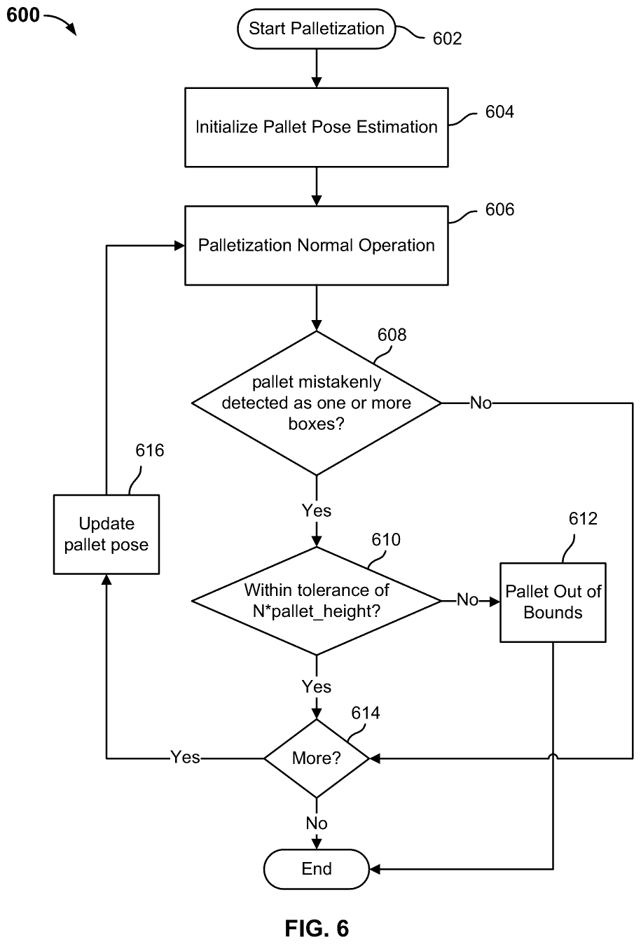

FIG. 6 is a flow chart illustrating a process to palletize, in an embodiment of a workspace adaptive robotic system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A workspace adaptive robotic system to load or unload pallets or other receptacles is disclosed. In various embodiments, a system as disclosed herein adapts to a workspace in which a pallet or other receptacle may be positioned on a stack of one or more empty pallets (or other receptacles). For example, in various embodiments, the system is configured and/or equipped to distinguish between items on a topmost pallet in a stack and the pallet itself, even if the pallet is stacked on one or more other pallets.

In various embodiments, a system as disclosed herein is configured and used to remove or add items from/to a pallet or other receptacle that may (or may not) be positioned on a stack of one or more other pallets or other receptacles.

In prior approaches, in which only a single pallet (or other container) was placed for depalletization/palletization, for example, at a given time, the system could be configured to only picked items that have a top surface that is above a certain height, e.g., the known or estimated height of a single pallet. Such an approach would not work if items are to be retrieved from multiple pallets. For example, the topmost pallet on a stack might be above the prescribed height. In various embodiments, one or more of a computer visions/perception system and associated heuristics may be used to distinguish between a pallet on top of a stack of pallets and an item on the topmost stack.

While in various embodiments described herein the robotic system is described as performing depalletization (removing items from a pallet) or palletization, in various embodiments techniques disclosed herein may be applied to adding items to or removing items from other stackable (or nesting) receptacles, including without limitation bins, trays, totes, containers, and other receptacles.

In various embodiments, the following new workflow is implemented (using palletizing operation as example):

Multiple Pallets on the ground→Palletize objects on the top pallet→Continue until all possible objects are onto the top pallet→Remove top full pallet→Continue onto empty pallet underneath (if present)->Repeat for all pallets underneath until done->Detect next stack of empty pallets has been placed (if needed), etc.

FIG. 1 is a block diagram illustrating an embodiment of a workspace adaptive robotic system. In the example shown, robotic system and environment 100 includes robotic arm 102 having a suction-type end effector 104. Robotic arm 102 and end effector 104 are operated in an autonomous mode of operation under control of control computer 105, in this example to remove boxes from pallets on either side of robotic arm 102, e.g., boxes 106 on the topmost pallet of stack 108.

In various embodiments, robotic arm 102, 104 removes boxes from a topmost pallet on one side of the other until the topmost pallet has been emptied. While the robotic arm 102, 104 is working on one side, a forklift or other equipment (which may itself be a robot) places a full pallet on the top of the stack on the non-working side, and so on, until a maximum stack height is reached (e.g., 4, 5, or n pallets). Only then are empty pallets removed prior to placing a next full pallet.

Referring further to FIG. 1, in the state shown robotic arm 102 and end effector 104 are being used to remove boxes 106 from the topmost pallet in stack 108. Each box is placed singly on conveyor 110, see, e.g., box 112, which carries the boxes downstream in the direction of the arrow shown next to conveyor 110, e.g., for scanning, routing, and/or other processing. A single empty pallet 114 is shown on the opposite side of robotic arm 102. Control computer 105 receives image data from one or more cameras in the workspace, e.g., camera 118. In various embodiments, camera 118 and/or one or more other cameras in the workspace may comprise a 3D that provides 2D red-blue-green (or other 2D) pixel information and depth pixel information. A computer vision module running on control computer 105 uses the image data to generate an at least partial 3D view of the workspace and items in the workspace. The image data is used to classify items in the workspace, e.g., an item may be classified as a box rather than a pallet (or other stackable receptable). In the example and state shown in FIG. 1, for example, the computer may determine based on the image data that the pallet 114 is empty and stack only 1 pallet high. In the state shown in FIG. 1, control computer 105 has invoked an autonomous/robotic forklift or other autonomous robot 120 to retrieve a pallet 122 with boxes 124 stacked thereon to be placed by robot 120 on top of pallet 114.

In various embodiments, as pallets are emptied further full pallets would be brought to the workspace shown in FIG. 1 and added to the stack of empty pallets up to a pallet stack height/number limit, e.g., four pallets or any prescribed maximum “n” number of pallets. Once the prescribed maximum is reached, an autonomous forklift or other robot is called to retrieve and remove the stack of empty pallets prior to a next full pallet being retrieved and place in the spot made available by removal of the stack of empty pallets. Processing continues in the same manner until all full pallets have been processed.

While the robotic system of FIG. 1 is described above as being used to depalletize boxes, e.g., 106, 112, 124, and place them singly on conveyor 110, in other contexts and/or systems robotic arm 102, 104 may be used to pick boxes carried in by conveyor 110 and place them on pallets on one side or the other of the robotic arm 102, 104. A stack of empty pallets, e.g., n pallets high, is place on a mark next to the robotic arm 102, 104; the robotic arm 102, 104 picks boxes (or other items) from conveyor 110 and stacks them on the top most pallet; when a pallet is full an autonomous robot retrieves and removes the full pallet; if a next empty pallet is exposed it is filled; if the removed pallet was the last one in the stack a new stack of empty pallets is brought; and so on, until done.

While FIG. 1 shows pallet stacks on either side of the robotic arm 102, 104, in various embodiments stacks may be placed/built at one or more locations adjacent to the robotic arm 102, 104, e.g., two, three, or more locations, limited only by the available space adjacent to and reach of the robotic arm 102, 104.

FIGS. 2A-2F are diagrams illustrating an embodiment of a workspace adaptive robotic system. In the example shown, system and environment 200 includes a robotic arm 202 having an end effector 204. As shown in FIG. 2A, robotic arm 202 and end effector 204 are being used to pick boxes 206 from topmost pallet on stack 208, shown to the left of robotic arm 202. A single empty pallet 210 is positioned to the right of robotic arm 202. For example, robotic arm 202 and end effector 204 may have been used to pick and remove boxes or other items from pallet 210, e.g., prior to turning to the task of picking boxes 206 from the topmost pallet of stack 208, as shown in FIG. 2A.

In the state shown in FIG. 2B, robotic arm 202 and end effector 204 have completed picking the boxes 206 from the topmost pallet of stack 208. In the meantime, while robotic arm 202 and end effector 204 have completed picking the boxes 206 from the topmost pallet of stack 208, a new pallet 212 with boxes 214 stacked thereon has been placed on top of pallet 210. For example, a human with a forklift or another robot, such as an autonomous robotic forklift, may have place pallet 212 with boxes 214 stacked thereon on formerly empty pallet 210.

In the state shown in FIG. 2C, robotic arm 202 and end effector 204 are shown being used to pick boxes 214 from pallet 212 stacked on pallet 210. In the meantime, a new pallet 216 with boxes 218 stacked thereon has been placed on top of stack 208.

FIG. 2D shows a state after robotic arm 202 and end effector 204 have been used to complete picking of boxes 214 from atop pallet 212 and have turned to and in fact finished picking boxes 218 from pallet 216 atop stack 208. While robotic arm 202 and end effector 204 were being used to pick boxes 218 from pallet 216, a third pallet 220 having boxes 222 stacked thereon has been placed atop the stack comprising pallets 210 and 212.

In the state shown in FIG. 2E, a human worker or autonomous robot has removed the stack of four empty pallets from the left side of robotic arm 202, i.e., pallets 208 and 216, as robotic arm 202 and end effector 204 are used to remove boxes 222 from pallet 220. In this embodiment, the pallet stack height may be limited to four pallets, for example.

Finally, FIG. 2F shows a state in which a new pallet 224 with boxes 226 stacked thereon has been place to the left of robotic arm 202, e.g., by a human worker using a forklift or similar equipment and/or by an autonomous robot, while robotic arm 202 and end effector 204 continue to be used to remove boxes 222 from pallet 220.

While FIGS. 2A through 2F illustrate an example of depalletization, in various embodiments similar processing may be performed, essentially in reverse, to palletize. For example, a stack of empty pallets may be placed in a prescribed location adjacent to a robot, and the robot used stack boxes or other items on the topmost pallet, until full. The completed pallet may be wrapped (or not) and removed from the stack of remaining empty pallets, e.g., by a human or robotic worker. Processing may continue until the bottommost pallet in the stack has been loaded. Once that loaded pallet has been removed, a new stack of empty pallets may be placed in the prescribed location, and so on.

In the example illustrated by FIGS. 2A through 2F on the preceding two pages, the system only requires pallet removal to be performed every fourth pallet, as compared to after every pallet as in the typical system. In other systems, pallets or other containers may be stacked five or more high. In various embodiments, pallets (or other receptacles) can be stacked onto empty pallets so long as the total height of pallets+boxes (or other items) are below a prescribed maximum height, e.g., a height associated with the highest height from which a robotic arm can grasp items from the topmost pallet on the stack.

Instead of swapping pallets every single time there is an empty or full pallet, pallet (or other receptacle) stacking enables an operator, whether human or robotic, to feed the system in a more efficient way.

For example, with pallet stacking, the operator, forklift driver, or autonomous mobile robot forklift can stack a full pallet with boxes on an empty one.

In various embodiments, utilization of a robotic system as disclosed can be improved from 50-60%, compared to typical prior systems, to >85%. For example, a robot may be able to pick and place one box in 5.5 seconds, or about 650 boxes in 60 minutes. In a typical system only 325 boxes might be picked in an hour, due to the downtime associated with waiting for empty pallets to be removed, since in any given hour 30 minutes may be lost swapping pallets. By contrast, using techniques disclosed herein, 550 or more boxes may be picked per hour.

Much greater throughput is achieved using the same hardware (i.e., robotic arm, forklift, etc.) and in the same space, without requiring additional ancillary equipment, e.g., to remove empty pallets more quickly or add new full ones.

In various embodiments, a robotic system as disclosed herein includes and/or provides one or more of the following:
1. Improved workflow and throughput by stacking pallets/containers
   multiple pallets/containers may be stacked, either by adding new full pallets/containers to a stack as items are removed or by placing a stack and starting to fill at the top
2. Depth estimation of the different pallets/containers using 3D vision
   System uses 3D vision such that the machinery does not crush gripper or products into pallets at different heights
   Auto adjust the starting point based on the pallet surface
3. Lateral/Horizontal estimation of the different pallets using 3D vision
   As pallets become stacked, there can be lateral offsets or tilting that the robot system needs to overcome
4. Accuracy of the different pallets/containers/trays using 3D vision
   Auto adjust the corner starting point based on the pallet surface, e.g., to know where to begin placing items
   Adjusts for slotting of plastic pallets/trays/containers from 3D vision; model+heuristics to distinguish
5. Distinguishing between a pallet vs/a layer of boxes using 3D vision
   Integration with Closed Loop Vision Feedback/“Cold Start” to avoid mistaking pallet slats for distinct boxes, or a layer of distinct boxes as a pallet, for accurate stability computations
   Apply heuristics to avoid mistaking a pallet for a box, e.g., short flat item identified as a “box” with pallet top dimensions is a pallet (or slip sheet); pallet-wide narrow “boxes” laid in a row are slats, etc.
6. Estimation of a pallet stack in the presence of boxes on the pallet
   Allowing for the possibility of partially built pallets being inserted, e.g., on top of a stack; distinguish pallet from items, set partially full state,
   Safety & error-handling

In various embodiments, RGB segmentation and computer vision models may be used to detect boxes versus pallet surface in the first instance, heuristics are applied in various embodiments to further ensure boxes are not mistaken for a pallet and vice versa. The system thereby avoids incomplete depalletization, incorrect item placement when palletizing, mistakenly grasping a pallet, as if it were a box, etc.

FIGS. 3A-3D are diagrams illustrating examples of pallets in various states of being loaded or unloaded, in an embodiment of a workspace adaptive robotic system.

FIG. 3A shows a set of boxes 302 placed on a pallet 304. The boxes 302 have a substantially uniform height, resulting in a top surface that in some circumstances could potentially be misidentified by a robotic system as comprising the top surface of a pallet.

In various embodiments, one or more heuristics and/or techniques disclosed herein may be used to distinguish between boxes and pallets, including in situations where the top surfaces of a set of boxes, such as boxes 302 of FIG. 3A, present a surface of substantially uniform height.

One technique, shown in FIG. 3B, involves using RGB or other video segmentation to identify the boundaries of each box included in the set of boxes 302. In this way, even small gaps between the boxes 302 may be discerned and the surface determined to comprise the tops of adjacent boxes, rather than a pallet.

FIG. 3C shows a stack of pallets 322 having a topmost pallet 324. A location and orientation of corner 325 of pallet 324 have been determined, e.g., via computer vision. Boxes 326 stacked on pallet 324 may be easily identified as boxes, rather than a pallet or surface thereof, e.g., due to their varied and substantial height. In some embodiments, a box such as box 328, having a height closer to that of a pallet, may not be identified as a box, as opposed to a pallet, based on height alone. In various embodiments, one or more other and/or additional criteria or heuristics may be applied to distinguish between a pallet-height box and a pallet. For example, the top surface area of the object (e.g., box 328) may be compared to the area of the top surface of a pallet, such as pallet 328. If the top surface area of the item is significantly smaller than the area of a pallet, it is determined to be a box.

Referring further to FIG. 3C, box 330 has nearly the height of a pallet and a larger top surface area. In various embodiments, box 330 may be identified as a box, not part of the top surface area of pallet 324, by noting the difference in height, i.e., between the top of box 330 and the pallet 324. Box 330 may be identified as a box and not as a pallet stacked on pallet 324 by one or more of its height, its surface area, and the presence of boxes 326, 328 having different bottom heights.

FIG. 3D shows a pallet 340 the top surface of which is formed by a series of parallel boards 342 spaced apart by gaps of substantially uniform width. In various embodiments, the pallet 340 may be identified programmatically as a pallet, as opposed to a series of wide flat boxes, by recognizing that the height of boards 342 is a whole number multiple of the height of a pallet.

FIG. 4 is a flow chart illustrating a process to depalletize, in an embodiment of a workspace adaptive robotic system. In various embodiments, process 400 of FIG. 4 may be implemented by a control computer comprising a robotic system, such as control computer 105 of FIG. 1. In the example shown, an indication to begin depalletization (402) is received and normal, autonomous depalletization operations begin (404). If a (next) box to be depalletized is found (406) processing is performed to verify the item thought to be a box is not instead a pallet (or portion thereof) that has been identified mistakenly to be a box (408).

If a next box identified to be depalletized is NOT found to instead be a pallet (406, 408, 410), i.e., it really is a box, then depalletization processing is performed with respect to the item (404), e.g., a strategy is determined and implemented to pick the box from the pallet and place it in a corresponding destination (e.g., conveyor 110, in the example shown in FIG. 1).

If the next item (thought to be a box) is determined to instead be a pallet (410), then the depalletization operation reclassifies the item as a pallet moves on to continue operation with respect to a next item identified as a box (404, 406, 412), unless no items remain (412, 414). If all items not determined to be a pallet have been processed (406, 412) processing ends (414).

FIG. 5 is a flow chart illustrating a process to check that a pallet has not been identified mistakenly as a box in an embodiment of a workspace adaptive robotic system. In various embodiments, the process of FIG. 5 may be implemented by a control computer comprising a robotic system, such as control computer 105 of FIG. 1, e.g., to perform step 408 of the process 400 of FIG. 4. In the example shown, if the item/box height is greater than the maximum pallet stack height (502), OR if all the boxes/items on the same layer have different heights (506), OR the sum of the box (e.g., box top) area is not a significant fraction of the pallet surface area (508), AND it has not already been determine that there is a pallet at the item height, then the item/box is determined to NOT be a pallet (504), i.e., “no” result for step 410 of FIG. 4. If any one or more of the conditions associated with the item instead being a pallet are true (502, 506, 508, 510), the item is determined to be a pallet (512), not a box, i.e., the “yes” result for step 410 of FIG. 4

FIG. 6 is a flow chart illustrating a process to palletize, in an embodiment of a workspace adaptive robotic system. In various embodiments, process 600 of FIG. 6 may be implemented by a control computer comprising a robotic system, such as control computer 105 of FIG. 1. In the example shown, at the start of palletization (602) the pallet pose estimation is initialized (604). For example, a prescribed or identified corner of a pallet and the pallet's orientation may be detected using computer vision. Normal, autonomous palletization operations begin (606). As items are detected and determined to be boxes to be added to the pallet (606) processing is performed to verify an item determined to be a box is not instead a pallet (608). In some embodiments, the process of FIG. 5, or a variant thereof, may be used.

If no item identified as a box is determined to instead be a pallet (608) and further items remain to be processed (614), the pallet pose (e.g., a model, representation, or other data reflecting pallet location and orientation) is updated (616), i.e., to reflect addition of one or more boxes placed on the pallet, and palletization continues (606).

If an item identified as a box is determined to instead be a pallet (608) and the height of the item is within a prescribed tolerance of a whole number multiple of single pallet height, the whole number not exceeding the prescribed maximum number of pallets in a stack (610), and if further items remain to be processed (614), the pallet pose (e.g., a model, representation, or other data reflecting pallet location and orientation) is updated (616) and palletization continues (606).

If an item identified as a box is determined to instead be a pallet (608) and the height of the item is NOT within a prescribed tolerance of a whole number multiple of single pallet height (610), the pallet is determined to be “out of bounds” and the process 600 ends. For example, a human worker may be called to assess and resolve the situation.

Otherwise, processing continues until all items required to be palletized have been processed (614), upon which the process ends.

In various embodiments, techniques disclosed herein may be used to provide a robotic item handling system that adapts to changes and/or variability in a workspace, such as the height of a pallet top or other surface or container from which the robot is configured to remove items (e.g., depalletization, singulation/sortation) and/or onto or into which the robot is configured to place/stack items (e.g., palletization, kitting).

In various embodiments, stacks of pallets or other receptacles may be built or provided. For example, successive full containers may be added on top of a stack of previously emptied containers, up to a prescribed or dynamically determined stack height, for example. Or, a stack of empty receptacles may be placed, and a robot used to successively fill them, each being taken from the top of the stack as it is completed being filled, exposing the next empty one on the top of the stack for filling.

In various embodiments, techniques disclosed herein may be used to provide a robotic system to load/unload a pallet or other receptacle with high efficiency and throughput.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a communication interface configured to receive image data; and
a processor coupled to the communication interface and configured to:
use the image data to identify an item associated with a topmost receptacle in a stack of one or more stackable receptacles;
control a robotic arm to perform a pick and place operation on the item with respect to the topmost receptacle in the stack of one or more stackable receptacles; and
continue successive iterations of identifying, picking, and placing items, until a stop condition is determined to have been met, the stop condition including one or more of determining no further items remain to be processed and determining that the stack of one or more stackable receptacles includes a maximum permitted number of stackable receptacles.

2. The system of claim 1, wherein the stackable receptacles are pallets.

3. The system of claim 1, wherein the robotic system is configured to perform an operation that entails removing items from stackable receptacle in the stack and placing each in an associated destination location, and the stop condition includes determining no further items remain in the topmost receptacle and determining that the stack of one or more stackable receptacles includes the maximum permitted number of stackable receptacles.

4. The system of claim 3, wherein the processor is further configured to cause the stack of one or more stackable receptacles to be removed and replaced with a receptacle having one or more items to be removed.

5. The system of claim 4, wherein the processor is configured to cause the stack of one or more stackable receptacles to be removed at least in part by invoking an operation by an autonomous robot to remove the stack of one or more stackable receptacles.

6. The system of claim 4, wherein the processor is configured cause the stack of one or more stackable receptacles to be replaced with the receptacle having one or more items to be removed at least in part by invoking an operation by an autonomous robot to retrieve the receptacle having one or more items to be removed and place the receptacle having one or more items to be removed in a location adjacent to the robotic arm.

7. The system of claim 6, wherein location adjacent to the robotic arm comprises a location from which the stack of one or more stackable receptacles was removed.

8. The system of claim 1, wherein the item comprises a first item, the stack of one or more stackable receptacles comprises a first stack of one or more stackable receptacles at a first location adjacent to the robotic arm, and the processor is further configured to:
use the image data to identify a second item associated with a topmost receptacle in a second stack of one or more stackable receptacles at a second location adjacent to the robotic arm; and
control a robotic arm to perform a pick and place operation on the second item with respect to the topmost receptacle in the second stack of one or more stackable receptacles.

9. The system of claim 8, wherein the processor is configured to perform pick and place tasks successively with respect to items associated with the first stack of one or more stackable receptacles until the stop condition is determined to be met with respect to the first stack of one or more stackable receptacles, and turn to performing pick and place tasks successively with respect to items associated with the second stack of one or more stackable receptacles based at least in part on the determination that the stop condition has been met with respect to the first stack of one or more stackable receptacles.

10. The system of claim 9, wherein the processor is further configured to cause the stop condition to be cleared with respect to the first stack of one or more stackable receptacles, while items are being picked and placed with respect to the second stack of one or more stackable receptacles.

11. The system of claim 10, wherein the stop condition is cleared with respect to the first stack of one or more stackable receptacles, at least in part, by removing the first stack of one or more stackable receptacles.

12. The system of claim 10, wherein the stop condition is cleared with respect to the first stack of one or more stackable receptacles, at least in part, by replacing the first stack of one or more stackable receptacles with a full receptacle.

13. The system of claim 10, wherein the stop condition is cleared with respect to the first stack of one or more stackable receptacles, at least in part, by adding a full receptacle to the top of the first stack of one or more stackable receptacles.

14. The system of claim 1, further comprising a camera configured to generate the image data.

15. The system of claim 14, wherein the camera comprises a 3D camera.

16. The system of claim 15, wherein the processor is configured to provide a computer vision module configured to use the image data to generate a three dimensional view of a workspace in which the robotic arm, the item, and the stack of one or more receptacles are located.

17. The system of claim 1, wherein the stop condition includes a determination that the topmost receptacle is full and the processor is further configured to cause the topmost receptacle to be removed from the stack of one or more stackable receptacles.

18. The system of claim 1, wherein the processor is further configured to verify that the item is not a stackable receptacle.

19. A method of controlling a robotic arm, comprising:
receiving image data;
using the image data to identify an item associated with a topmost receptacle in a stack of one or more stackable receptacles;
controlling the robotic arm to perform a pick and place operation on the item with respect to the topmost receptacle in the stack of one or more stackable receptacles; and
continuing successive iterations of identifying, picking, and placing items, until a stop condition is determined to have been met, the stop condition including one or more of determining no further items remain to be processed and determining that the stack of one or more stackable receptacles includes a maximum permitted number of stackable receptacles.

20. A computer program product to control a robotic arm, the computer program product being embodied in a non-transitory computer readable medium and comprising computer instructions for:
receiving image data;
using the image data to identify an item associated with a topmost receptacle in a stack of one or more stackable receptacles;
controlling the robotic arm to perform a pick and place operation on the item with respect to the topmost receptacle in the stack of one or more stackable receptacles; and
continuing successive iterations of identifying, picking, and placing items, until a stop condition is determined to have been met, the stop condition including one or more of determining no further items remain to be processed and determining that the stack of one or more stackable receptacles includes a maximum permitted number of stackable receptacles.
